(19) United States
(12) Patent Application Publication
(10) Pub. No.: US 2008/0162604 A1
(43) Pub. Date: Jul. 3, 2008

(54) System and Method For Migrating a Platform, User Data, and Applications From at Least One Server to at Least One Computer

(76) Inventors: Serge Soulet, Rennes (FR); Jean-Marc Vuillaume, Acigne (FR)

Correspondence Address: COHEN, PONTANI, LIEBERMAN & PAVANE, 551 FIFTH AVENUE, SUITE 1210, NEW YORK, NY, 10176, US

(21) Appl. No.: 11/885,205

(22) PCT Filed: Mar. 1, 2006
(86) PCT No.: PCT/FR06/50180

§ 371 Date: Aug. 24, 2007

(30) Foreign Application Priority Data
Mar. 1, 2005 (FR) 0502045

(51) Int. Cl. G06F 17/00

(52) U.S. Cl. 707/204; 707/E17.005

(57) ABSTRACT

A method and a system for migrating an operating system and applications from a server to a computer connected to said server via an information network (13), including a synchronization server (1) connected to a downloading server (5), an inventory server (7), and a back-up server (9) adapted to effect the migration by automatically chaining a set of steps organized as a function of initial data and/or interaction between said computer (15a) and said servers and including initializing said computer, analyzing said computer to verify whether it can support the migration, and loading said operating system and said applications onto said computer.

### FIELD OF THE INVENTION

The invention relates to the field of migrating workstations of organizations having a large installed computer base, and more particularly the field of migrating an operating system, user data, and applications from a server to a computer.

### BACKGROUND OF THE INVENTION

As a general rule, workstations are migrated, for example from one Windows™ system to another, manually using CD-ROMs containing the workstation masters.

Before migration, it is necessary for a technician, working station by station, to analyze the characteristics of a station (data to be backed up, printer parameters, network connections, installed software, etc.), to back up that data manually, to change the operating system, and then to restore the data and parameters. All these tasks require several hours' work by an experienced technician to install a workstation. Monitoring the status of migrations and balances can be centralized only using files that are updated manually.

However, certain producers, for example Symantec™, offer centralized tools for updating an operating system, but those tools take no account whatsoever of the data and parameters of users.

Moreover, other producers, for example Microsoft™, supply a limited number of tools that do take account of data and parameters, but those tools are incomplete and very complex and can be used only manually.

### OBJECT AND SUMMARY OF THE INVENTION

An object of the invention is to remove these problems by centralizing and automating the migration of workstations.

That object is achieved by a method of migrating an operating system, user data, and applications from a server to a computer connected to said server via an information network, wherein migration is effected by automatically chaining a set of steps organized as a function of initial data and/or interaction between said computer and said server, said steps comprising:
initializing said computer;
analyzing said computer to verify whether it is able to support the migration; and
loading said operating system, said user data, and said applications onto said computer.

Thus the method of the invention provides centralized and entirely automated migration of a plurality of workstations, thereby reducing the time required for such migration.

When a next step must be executed after a preceding step, said preceding step advantageously includes a final command for initiating automatic starting of the next step.

Thus migration is automated in a simple way enabling initiation of the successive steps to be monitored and a restart in the event of an error.

According to one feature of the invention, the initial data is stored by a person who requested the migration in a database of a synchronization server and includes a migration type, times of execution of the steps, and the name(s) of said computer and/or its user(s).

Thus the various steps are scheduled in advance to provide for successful and rapid migration.

According to a first aspect of the invention, initialization is effected by automatically chaining a first set of steps comprising:
the synchronization server requesting a downloading server to install a program necessary for said migration type on said computer;
the downloading server installing said program on said computer;
the downloading server executing said program; and
the synchronization server initiating a next step as a function of said migration type.

Thus the computer to be migrated is thoroughly prepared to undergo the various migration steps.

According to a second aspect of the invention, analyzing said computer comprises automatic chaining of a second set of steps comprising:
making an inventory of said computer comprising lists of installed applications and/or profile(s) of the user(s) and technical and technical and location parameters of said computer and storing said inventory in the database of the synchronization server; and
the synchronization server initiating a next step as a function of the migration type.

Thus it is easy to verify whether the computer is able to support the migration tools and whether there is at least one user profile on the computer.

According to a third aspect of the invention, analyzing said computer further comprises automatic chaining of a third set of steps comprising:
analyzing the capacity of said computer to support the migration;
sending information to the synchronization server for interrupting the automatic process if said computer does not have the capacity necessary for the migration until modification of said computer enables it to support the migration;
restarting the automatic process when said computer has the capacity to support said operating system; and
the synchronization server initiating a next step as a function of the migration type.

Thus migration can be stopped or restarted automatically according to the variation of the capacity of the computer to support the migration tools.

According to a fourth aspect of the invention, loading said operating system onto said computer comprises automatic chaining of a fourth set of steps comprising:
cleaning up the storage disk of said computer to make room for depositing an image of said operating system by eliminating files known to be unnecessary in the database of the synchronization server;
depositing said image of said operating system on said storage disk of said computer; and
the synchronization server initiating a next step as a function of the migration type.

Thus the computer is prepared in a secure and effective manner to enable it to accept an image in advance.

Said downloading server advantageously deposits said image of said operating system on said storage disk of said computer by communicating to said computer either the name of a depositary computer of said image, i.e. a computer belonging to the same local area network as said computer that has previously downloaded said image, or the address of a central storage location containing said image if there is not another computer in said local area network that has previously downloaded said image.

Thus a large volume of data can be deposited securely and quickly in all the computers to be migrated without saturating the information network.

According to a fifth aspect of the invention, the method further comprises a step of preparing to back up data of said user(s) comprising automatic chaining of a fifth set of steps comprising:
the person who requested the migration choosing profiles to be backed up from profiles found on said computer;
said person who requested the migration choosing wanted applications to be reinstalled after migration from among the applications found on said computer and/or from a list of available applications;
determining the storage volume necessary for backing up the data corresponding to the chosen profile(s) and application(s);
the synchronization server reserving said storage volume on a back-up server; and
the synchronization server initiating a next step as a function of the migration type.

Thus the volume of data to be backed up can be chosen according to the capacity of the back-up computer and according to the amount of data.

According to a sixth aspect of the invention, the method further comprises a step of backing up data of the user(s) comprising automatic chaining of a sixth set of steps comprising:
informing the user of the beginning of the back-up step to prompt the user to close his or her applications and session;
verifying that said computer contains no bootstrap external storage element and, if it does, sending an alert prompting the user to remove said bootstrap external storage element;
restarting said computer;
backing up data of the user(s) on said back-up server; and
the synchronization server initiating a next step as a function of the migration type.

Thus all precautions are taken to enable successful migration.

According to a seventh aspect of the invention, loading said operating system onto said computer further comprises automatic chaining of a seventh set of steps comprising:
loading said operating system onto said storage disk of said computer;
setting particular parameter values of said computer; and
the synchronization server initiating a next step as a function of the migration type.

Thus the computer is mastered quickly and efficiently.

According to a eighth aspect of the invention, the method further comprises a step of restoring backed up data comprising automatic chaining of a eighth set of steps comprising:
storing the backed up data on said computer;
verifying the quality of the backed up data; and
the synchronization server initiating a next step as a function of the migration type.

This optimizes the efficiency and quality of the restoration of data that has been backed up.

According to a ninth aspect of the invention, the method further comprises a step of installing said wanted applications chosen by said person who requested the migration before and/or after the restoration of said backed up data comprising automatic chaining of a ninth set of steps comprising:
the synchronization server requesting the downloading server to install a first application on said computer;
the synchronization server verifying correct installation of said application and effecting a particular number of retries if installation has failed;
the synchronization server requesting the downloading server to install a next application on said computer;
repeating the previous two steps until all applications chosen by said person who requested the migration have been reinstalled; and
the synchronization server initiating a next step of terminating operation or declaring a fault.

Thus all the necessary applications are installed, enabling the handing over to the user of a workstation in a good operating state and with as much information as possible recovered from the preceding version.

The invention is also directed to a computer program designed to execute the method with the above features when it is executed by an electronic data processing system.

The invention is further directed to a system for migrating an operating system and applications from a server to a computer connected to said server by an information network, the system comprising a synchronization server connected to a downloading server, an inventory server and a back-up server adapted to execute the migration by automatically chaining a set of steps organized as a function of initial data and/or interaction between said computer and said servers and comprising initializing said computer, analyzing said computer to verify that it is able to support the migration, and loading said operating system and said applications onto said computer.

### BRIEF DESCRIPTION OF THE DRAWINGS

Other features and advantages of the invention emerge on reading the description given below by way of non-limiting example and with reference to the appended drawings, in which:

FIG. 1 shows a workstation migration system of the invention for migrating an operating system and applications from a server to a computer connected to said server via an information network;

FIGS. 2 and 3 show examples of descriptions of a scenario and a migration operation in a database of a synchronization server of the invention; and

FIGS. 4 to 15 are diagrammatic flowcharts showing various steps that can be executed in several types of migration operation in accordance with the invention.

### DETAILED DESCRIPTION OF EMBODIMENTS

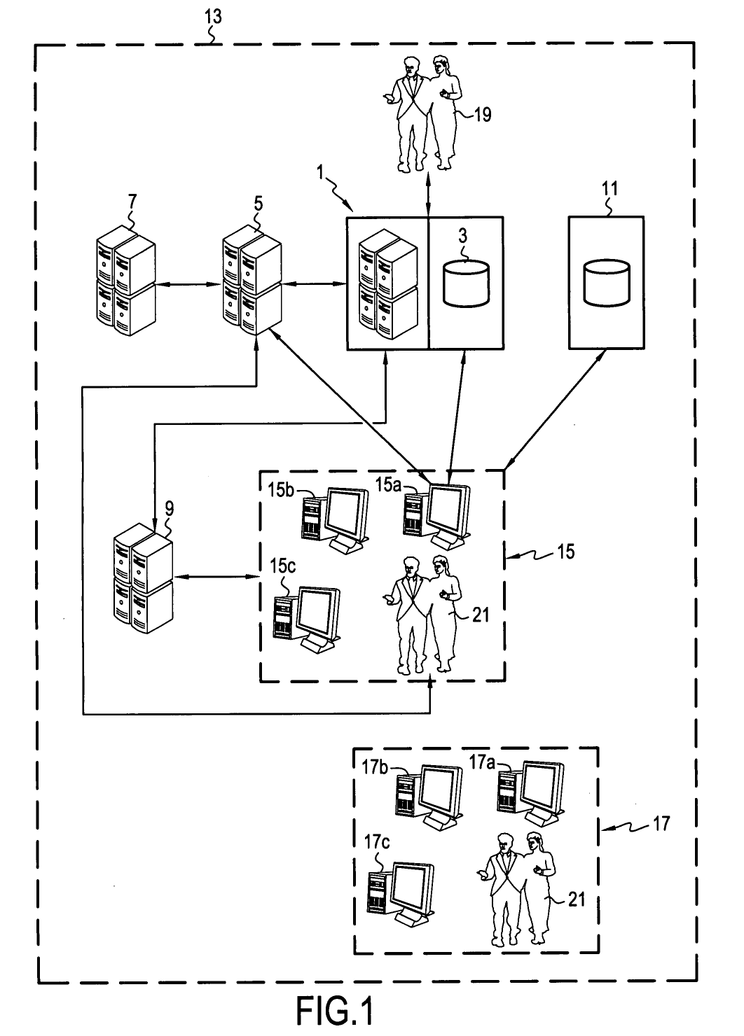

FIG. 1 shows an example of a workstation migration system of the invention for migrating an operating system and applications from a server to a computer connected to said server via an information network.

More particularly, this system includes a synchronization server 1 (including a database 3), a downloading server 5, an inventory server 7, a back-up server 9 and, where applicable, a central storage location 11. These servers are connected via an information network 13 to sets of workstations or computers 15a to 15c and 17a to 17c distributed over separate information local area networks 15 and 17, respectively.

The migration of a workstation associated with a particular computer 15a (i.e. a computer to be migrated) is effected by automatically chaining a set of steps (also referred to as scenarios) organized as a function of initial data and/or interaction between that particular computer 15a and the servers 1, 5, 7, 9. The initial data can be stored in the database 3 of the synchronization server 1 by a person 19 requesting the migration operation and can include the type of migration, the date of execution of the steps, and the name(s) of the particular computer 15a and/or its user(s) 21.

There can be several types of migration and each migration can include a plurality of steps or scenarios. Thus a migration can consist in migrating a user on the same computer, migrating a user to a new computer, mastering a workstation to reformat it or mastering a workstation for a new user.

Generally speaking, the objective of migration is to hand over a workstation to a user in a good operating state and with as much information as possible recovered from a preceding version.

Thus a migration is a set of steps or scenarios intended to address all problems that may be encountered during the migration process. As a general rule, the steps or scenarios of a migration include initializing the computer 15a, analyzing the computer 15a to verify that it is able to support the migration, and loading the operating system and applications onto the computer 15a.

A scenario is a succession of tasks (also referred to as steps), each task being a job to be executed on an electronic data processing system (also referred to as an “actor”, for example the servers 1, 5, 7, 9, the database 3, the computer 15a) involved in the migration process in order to produce a certain action. An action is a status resulting from a step. A PostAction is a program executed from the synchronization server 1 after an action has occurred (for example sending an e-mail). A PostAction can be responsible for executing a step that advances the status (the action).

Thus a scenario can be defined in respect of one or more actors (for example the actors 1, 3, 5, 9, 11, 15a) and the migration is then a succession of scenarios that are chained automatically by the synchronization server 1.

When a next scenario (next step) must be executed after a preceding scenario (preceding step), the preceding scenario includes a final command or task for initiating the automatic starting of the next scenario.

Thus the synchronization server 1 includes a first program capable of executing programs called by the PostActions and a second program (for example API SetAction) that can be called from any point of the information network 13 capable of taking into account the advancing of the status by the actors (the electronic data processing systems) in order to update the database 3 in the synchronization server 1.

The synchronization server 1 also includes a third program that can be called from any point of the information network 13 and is able to determine the next action to be communicated when solicited by an actor (for example API GetNextAction). Thus if API GetNextAction is called, for example, it checks that the action is not the last action of the scenario. If not, it executes a SetAction on the first action described in the next scenario.

The synchronization server 1 further includes a fourth program that can be called from any point of the information network 13 and is able to stop the migration process in the event of an error (for example API SetLastError).

Moreover, the database 3 of the synchronization server 1 includes a description of the scenarios (i.e. the actions or steps and their chaining), a description of the migrations (i.e. the scenarios and the order of execution of those scenarios as a function of the migration), and a description of a particular operation requested by the person 19 requesting the migration.

It is also necessary to have other programs that are executed on the actors (the electronic data processing systems) and must be able to execute the steps and advise the synchronization server 1 of the success or failure of a task by systematically informing the program of the synchronization server 1 (for example API SetAction).

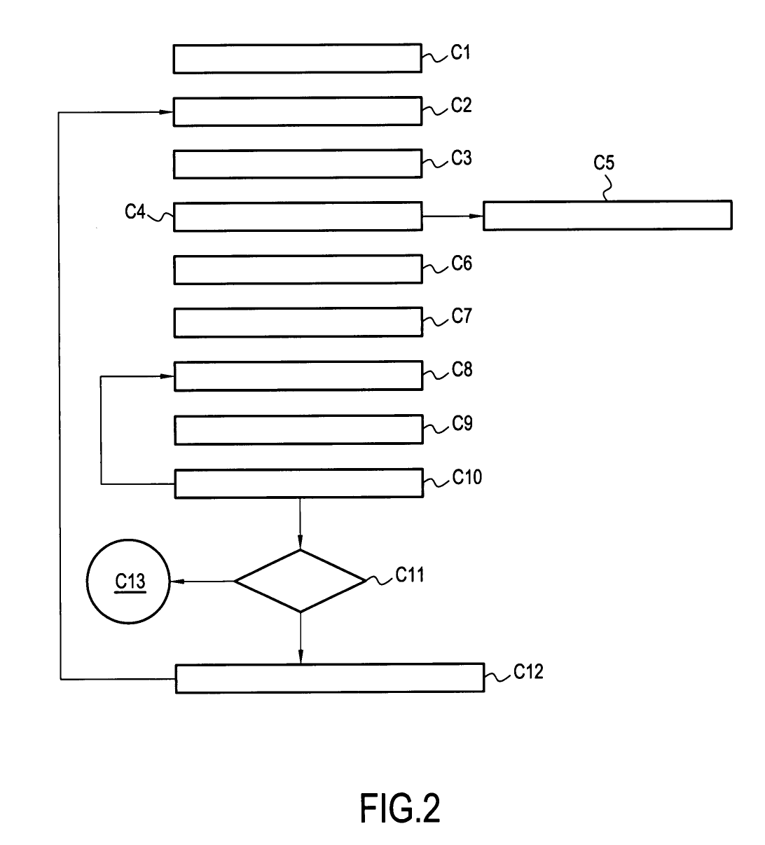

FIG. 2 shows the description of a scenario in the database 3 of the synchronization server 1.

The box C1 represents a description of a first scenario, the box C2 is the name of the scenario, the box C3 is a description of the actions with numbers giving the order of execution, and the box C4 is the name of the action. If the first action is named like the scenario the box C5 expresses the naming of a PostAction. The box C6 indicates that there is no preceding action number if the action is the first action of the scenario. The box C7 indicates that there is no next action number if the action is the last action of the scenario. The box C8 names the next action, the box C9 is the number of the preceding action, and the box C10 indicates that there is no next action number if the action is the last action of the scenario. The boxes C8 and C10 are looped until there remain no more actions to be described. The box C11 is a test to verify whether there are other scenarios. If yes, the box C12 describes the description of the next scenario before looping to the box C2. Otherwise, if there are no other scenarios, the box C13 indicates the end of the scenario.

Similarly, FIG. 3 shows how a migration is described in the database 3 of the synchronization server 1.

The box C21 represents a description of the operation and the box C22 indicates addition of a first scenario. The box C23 is a test to verify whether another scenario must be added. If yes, a next scenario is added to the box C24 before returning to the test C23. Otherwise, if there are no other scenarios to be added, then the box C25 indicates the end of the migration.

Thus the synchronization server 1 and its database 3 schedule the steps, monitor the execution thereof, initiate the next step, and to execute a restart in the event of an error.

Several scenarios are described below, each of which can be used in several types of migration.

A first scenario is an “initialization” scenario for preparing the computer 15a to undergo the actions to be effected by having the downloading server 5 deposit in it initialization programs necessary for the migration.

The initialization scenario is executed by automatically chaining a first set of steps.

In a first step the synchronization server 1 requests the downloading server 5 to install on the particular computer 15a a program necessary for the type of migration indicated in the initial data.

In a second step the downloading server 5 installs this program on the particular computer 15a.

In a third step the downloading server 5 executes this program before the synchronization server 1 initiates a next step as a function of the type of migration requested.

The particular computer 15a can be analyzed by means of two scenarios known as “source audit” and “target audit”.

The source audit scenario analyzes the computer 15a to verify that it is able to support the migration tools and that at least one user profile 21 exists on the computer 15a.

This source audit scenario includes automatic chaining of a second set of steps.

In a first step, the particular computer 15a draws up an inventory that is stored in the database 3 of the synchronization server 1. This inventory can include lists of the applications or software installed and/or of the profile(s) of the user(s) 21 and technical and geographical location parameters of the particular computer 15a.

In a second step the synchronization server 1 initiates a next step as a function of the type of migration.

Furthermore, the target audit scenario also analyzes the computer 15a or the workstation to verify that it is able to support the migration tools. Moreover, it is also verified that the computer is of a type that matches the type requested.

This target audit scenario includes automatic chaining of a first set of steps.

In a first step of the target audit scenario, the computer 15a analyses its capacity to support the migration. Then, in a second step, the computer 15a sends information to the synchronization server 1 to interrupt the automatic process if the computer 15a does not have the necessary capacity for the migration. The process is interrupted until the computer 15a is modified to enable it to support the migration.

The synchronization server 1 regularly consults its database 3 that contains the inventory. Accordingly, in a third step, the synchronization server 1 restarts the automatic process when the computer 15a has the capacity to support the operating system. The synchronization server 1 then initiates a next step as a function of the type of migration.

Moreover, loading the operating system onto the computer 15a includes a first scenario that deposits an image of the operating system on the computer 15a and a second scenario that is a mastering scenario. Note that the data and parameters of the user must be backed up before the mastering scenario is executed.

The image deposition scenario deposits a “ghost” image on the computer 15a in advance, given that the result of the distribution is relatively unimportant because it can be redistributed at the last moment if necessary.

This image deposition scenario includes automatic chaining of a fourth set of steps.

In a first step, using the program deposited and executed in the initialization scenario, the computer 15a cleans up its storage disk by eliminating files in the database 3 of the synchronization system 1 known to be unnecessary (for example .bak, .tmp, and ˜* files) to make room to deposit the image of the operating system, thereby maximizing the chance of the scenario succeeding. The downloading server 1 then deposits the image of the operating system on the storage disk of the computer 15a on a peer to peer basis before the synchronization server 1 initializes a next step as a function of the type of migration.

The image of the operating system is advantageously deposited on the storage disk of the particular computer 15a by the downloading server 5, which communicates to the particular computer 15a the name of a depositary computer (for example the computer 15b) of the image that belongs to the same local area network 15 as the particular computer 15a and that has previously downloaded that image. However, if the local area network 15 does not include another computer that has previously downloaded that image, the downloading server 5 communicates to the particular computer 15a the address of the central storage location 11 containing that image.

The process then includes a “confirmation” scenario that enables the person managing the migration or the person 19 who requested it to confirm that the volume of data to be backed up is not too large and to select which applications and software from those available are to be reinstalled.

It is not possible to restart this scenario. If the person 19 who requested the migration considers that the volume of data is too large, that person negotiates the elimination of some large or old files with the user 21 and then confirms that the volume of data to be backed up is not too large.

This confirmation scenario then prepares for backing up the data of the user(s) 21 and includes automatic chaining of a fifth set of steps.

In a first step the person 19 who requested the migration chooses which of the profiles found on the computer 15a are to be backed up and then chooses from the applications found on the computer and/or from a catalogue or list of available applications which applications to reinstall after migration.

In the next step the computer 15a determines the storage volume necessary for backing up the data corresponding to the chosen profile(s) and application(s) and informs the database 3 of the synchronization server 1 of this.

The synchronization server 1 then reserves that storage volume on the back-up server 9 before initiating a next step as a function of the type of migration.

The method advantageously includes a “back-up user data and parameters” scenario, if necessary copying messaging data to a remote server (not shown).

This scenario for backing up the data of the user(s) 21 includes automatic chaining of a sixth set of steps.

In a first step, the computer 15a informs the user 21 that the backing up step is starting and prompts the user to close his or her applications and session. The computer 15a then verifies that it contains no bootstrap external storage element (CD-ROM, diskette). If it does, the computer 15a prompts the user 21 to remove the bootstrap external storage element from the computer 15a. The subsequent steps concern restarting the computer 15a and the computer 15a backing up the data of the user(s) 21 on the back-up server 9. The synchronization server 1 then initiates a next step as a function of the type of migration.

After the data and parameters of the user(s) have been backed up, the mastering scenario masters the computer 15a, i.e. deposits the new operating system in place of that already present.

This mastering scenario includes automatic chaining of a seventh set of steps.

In a first step and using the program deposited and executed in the initialization scenario, the computer 15a loads the operating system onto its storage disk. Using the initialization program, the computer 15a sets its parameters in a particular way (strictly speaking this constitutes “post-parametering”). The synchronization server 1 then initiates a next step as a function of the type of migration.

The method further includes a “data restoration” scenario that restores all of the data of the user(s). This backed up data restoration scenario includes automatic chaining of an eighth set of steps.

The computer 15a first stores the backed up data and then verifies the quality of the backed up data. The synchronization server 1 then initiates a next step as a function of the type of migration.

The method further includes a scenario of reinstalling wanted applications and software chosen by the person 19 who requested migration before or after restoring the backed up data of the user(s) 21.

That scenario includes automatic chaining of a ninth set of steps.

In a first step, the synchronization server 1 requests the downloading server 5 to install a first application on the computer 15a.

In a second step, the synchronization server 1 verifies correct installation of the application. If installation has failed, the synchronization server 1 tries again (for example twice).

In a third step, the synchronization server 1 requests the downloading server 5 to install the next application on the computer 15a. The second and third steps are repeated until all the applications chosen by the person 19 who requested the migration have been reinstalled. The synchronization server 1 then initiates a next step as a function of the type of migration.

It should be noted that the migration method of the invention can be implemented by a plurality of computer programs (this plurality of programs is also referred to as a computer program) executed by the various actors or electronic data processing system (synchronization server 1, database 3, downloading server 5, inventory server 7, back-up server 9, computers 15a to 17c, etc.).

The remainder of the process constitutes one particular embodiment of the invention. An installed base of computers or microcomputers 15a to 15c and 17a to 17c is always migrated in the context of an information system having features specific to the organization using the information system.

There are several types of operation for migrating an installed base of computers.

A first example is an operation of migrating a user on the same computer, for example migration from a Windows 2000™ station to a Windows XP™ station.

This operation concerns the migration of one station for one user. In this operation there is no change of computer 15a or user 21, all of the data of the user 21 is recovered, and all the initially available software for which the installation package has been kept is reinstalled.

This first operation can consist in the following scenarios (steps) in this order: entry of the necessary information, initialization (source), audit (source), prevalidation (source), validation (source), image deposition (source) “ghost with CleanUp light”, operation reporting (source), backing up user data (source), mastering (target), initialization (target), software installation (target), restoration of user data (target), audit (target), and testing/canvassing.

A second example is an operation for migrating a user to a new computer.

This operation concerns the migration of one workstation for one user. This migration changes the computer. A user of a first computer is migrated to a second computer. All the data of the user is recovered and transferred and all the initially available software for which the installation package has been kept is reinstalled.

This second operation can include the following scenarios, in this order: entry of the necessary information, initialization (source), audit (source), initialization (target), audit (target), prevalidation (source), validation (source), image deposition (source) “Ghost with CleanUp light” operation reporting (source), backing up user data (source), mastering (target), initialization (target), software installation (target), restoration of user data (target), audit (target), and testing/canvassing.

A third example is an operation to master a workstation to be reconstructed.

This operation concerns mastering one workstation for one user. In this operation, the initial computer or machine of the user is not known (the user need not have had one). The necessary software is installed after mastering the machine.

This third operation can include the following scenarios, in this order: entry of the necessary information, initialization (target), audit (target), validation (source), mastering (target), initialization (target), software installation (target), audit (target), and canvassing.

A fourth example is an operation to master a workstation.

This operation concerns mastering a workstation with no immediate objective as to its use. It merely prepares the workstation for use in the future. The objective of this mastering is to provide a workstation ready to enter service upon the arrival of a new user.

This fourth operation can include the following scenarios in this order: entry of the necessary information, initialization (target), audit (target), mastering (target), initialization (target), and audit (target).

Thus each migration is a set of scenarios intended to address all problems thrown up by the migration or deployment process.

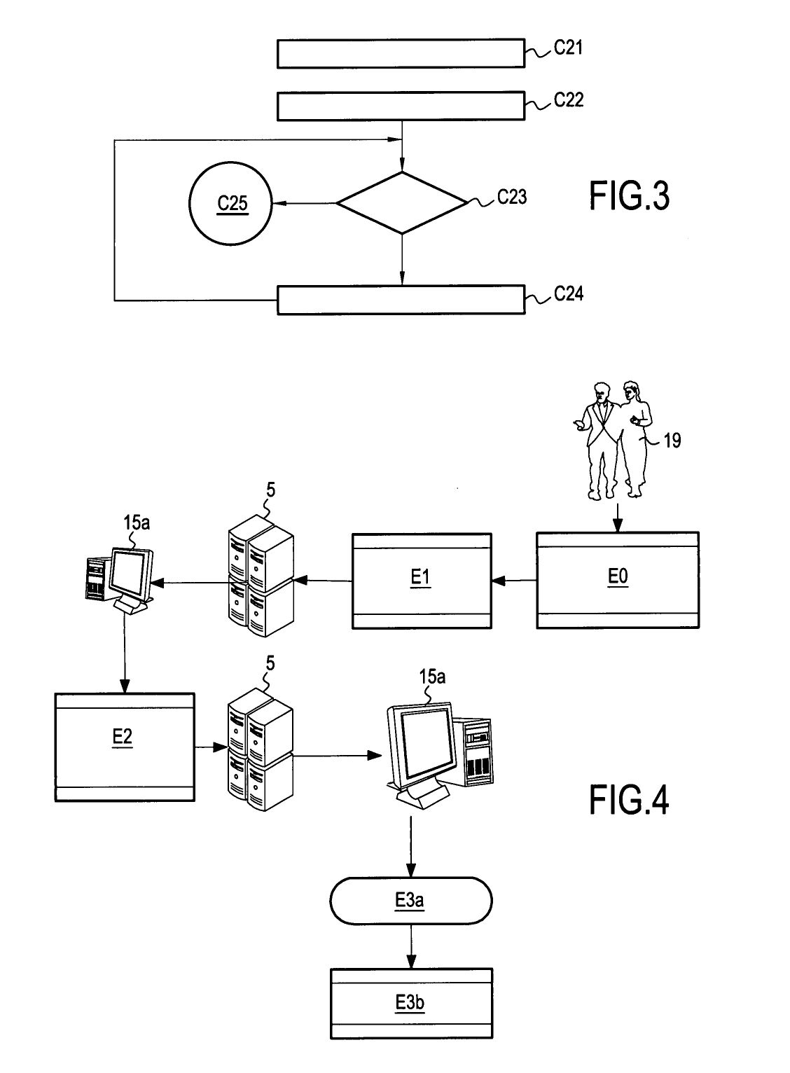

FIGS. 4 to 15 are flowcharts of various scenarios that can be executed in various types of migration.

Each scenario is a succession of steps or tasks necessary to achieve the objective fixed for the deployment of the migration. It should be noted that a scenario is executed only for a particular computer and that each scenario is executed in such a manner that it can be used in several types of migration.

FIG. 4 is a diagram of the initialization scenario for preparing the computer 15a to undergo the migration by downloading to it the “peer to peer” downloading (downloading server (5)) client, the synchronization server 1 client, inventory tools, and cloning tools.

The step E0 is a manual operation and is carried out at least the day before the migration, preferably or by default 10 days (D-10) before migration. The person 19 deploying or requesting the migration contacts the main user 21 of the workstation 15a to be migrated, recovers the user's connection identifier (login), station name, station type and required migration date (day D) and stores them in the database 3 of the synchronization server 1.

The person 19 verifies with the user 21 that the user is not using any software that is not supported by the new version (for example Windows XP). The request is registered via the website of the synchronization server 1. This step ends with a SetAction (STATION_CREATED) that generates a downloading request to the downloading server 5.

The package distributed deposits/installs the downloading server 5 client and deposits the dedicated program MMSetaction.exe. On completing installation of this client, the installation process executes the command MMSetAction.exe (DISTRIBUTOR_INSTALLED). This command is followed by a PostAction that executes the next step E2.

The step E2 is executed automatically on completion of installation of the downloading server 5 client. In it the distribution server 5 deposits the packages necessary for the following actions: deposition of the inventory scanner; deposition and installation of the synchronization server 1 client; deposition of the analysis and migration tools (MMClone.exe: Ghost image installation tool, MMProfiles.exe: tool for analyzing profiles found in the station, MMCleanUp.exe: tool for cleaning up the disk to be mastered, MMSigMigrXP.exe: tool for reporting the operation to the end user, MMInstl.exe: software reinstallation automaton, MMFileList.exe: user data back-up tool).

At the end of these distribution operations, a command SetAction (MM_INSTALLED) is executed.

The step E3a indicates that the “initialization” scenario has finished and the step E3b is the last action of the scenario, which consists in chaining the next scenario, which depends on the migration requested.

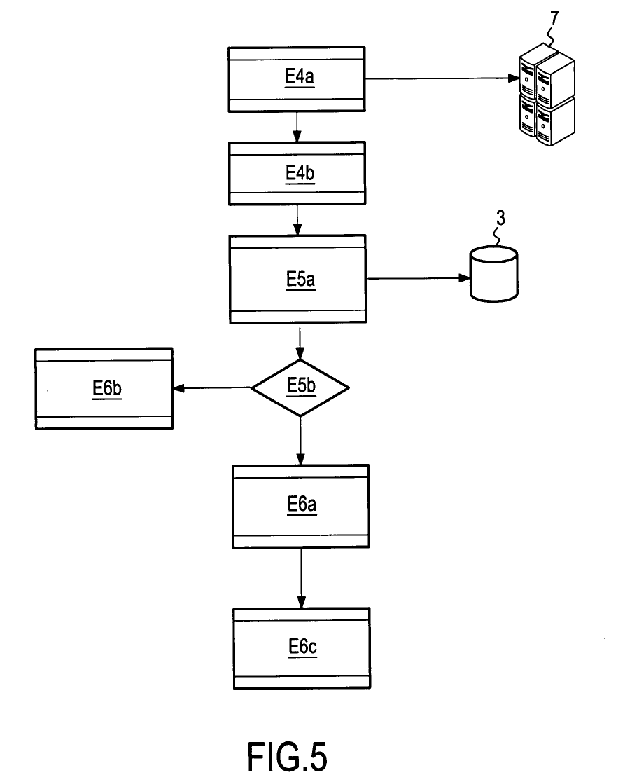

FIG. 5 is a diagram of the “source audit” scenario which analyzes the workstation 15a to verify that it is able to support the migration tools and that at least one user profile 21 exists in the workstation 15a.

The step E4a is initiated by the preceding scenario and launches an inventory of the workstation 15a. The inventory is specific to the synchronization server because the files generated by the scanner are deposited on a specific resource in order for the data to be acted on virtually immediately by the inventory server 7. The following are known at the time of this step: a list of the installed software, a list of the user profiles 21 present in the workstation 15a, the exact type of the workstation 15a (from which the image packet (ghost XP) to be deposited is deduced), the technical parameters of the workstation 15a (RAM, disk, etc.), and the geographical location of the workstation 15a.

The step E4a is initiated by the synchronization server. Note that the inventory in the inventory server 7 has been completed and that the inventory date is posterior to the request submitted. The action “26EOK” (inventory tool) is then set. This guarantees that the inventory is up-to-date.

In the step E5a (PostAction of the action 26EOK), the necessary data is imported into the database 3 of the synchronization server 1. The action 26EOK executes three PostActions, the last of which analyses the capacity of the workstation 15a to migrate.

The step E5b is a test to verify whether the workstation 15a supports the tested prerequisites (for example its capacity to support the software for backing up users' data and parameters). If yes, then the next step is the step E6a that simply informs the synchronization server 1 by a SetAction (AUDIT_OK).

If the workstation 15a does not support the tested prerequisites, then the next step is the step E6b in which the operation is stopped because an error is set on the scenario.

In the step E6c, the source audit scenario is completed and the last action of the scenario chains to the next scenario, which depends on the migration requested.

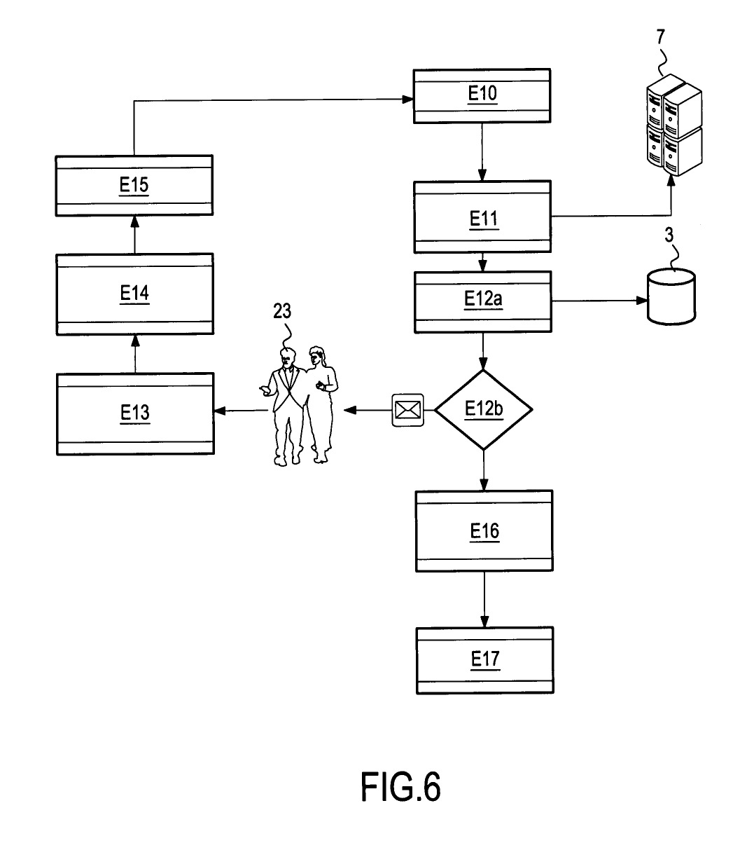

FIG. 6 is a diagram of the “target audit” scenario which begins with a step E10 that is initiated by a preceding scenario. This step launches an inventory on the workstation 15a. The inventory is specific to the migration because it includes in addition to the usual information a list of the users 21 of the workstation 15a. At this stage the following are known: a list of the installed software, the exact type of the workstation 15a (from which the package ghost XP to be deposited is deduced), the technical parameters of the workstation 15a (RAM, disk), and the geographical location of the workstation 15a (the name of the sub-network 15).

In the step E11, it is noted that the inventory has been completed in the inventory server 7 and the action 26EOK is then set.

In the step E12a (PostAction to the action 26EOK), the necessary data is imported into the database 3 of the synchronization server 1. The action 26EOK executes a PostAction which analyses the capacity of the station to migrate.

The step E12b is a test to verify whether the workstation 15a supports the tested prerequisites.

If the workstation 15a does not support the tested prerequisites, then the next step is the step E13, which is a manual operation (carried out by a local deployment operative 23, for example) which makes it technically possible for the workstation 15a to migrate (for example by adding memory).

The step E14 is executed on the synchronization server website by the person 19 who requested the migration, making it possible to unblock the situation when the technical operations of the preceding step have been completed. This reinitializes the prerequisites error message and indicates that the station has been updated by a SetAction (STATION_UPDATED).

The step E15 again verifies the technical prerequisites and returns to the step E10.

Following the test E12b, if the station 15a supports the tested prerequisites, the next step is the step E16 which simply informs the synchronization server 1 via a SetAction (AUDIT_OK).

In the step E17, the target audit scenario is terminated and the last action of the scenario chains to the next scenario, which depends on the migration requested.

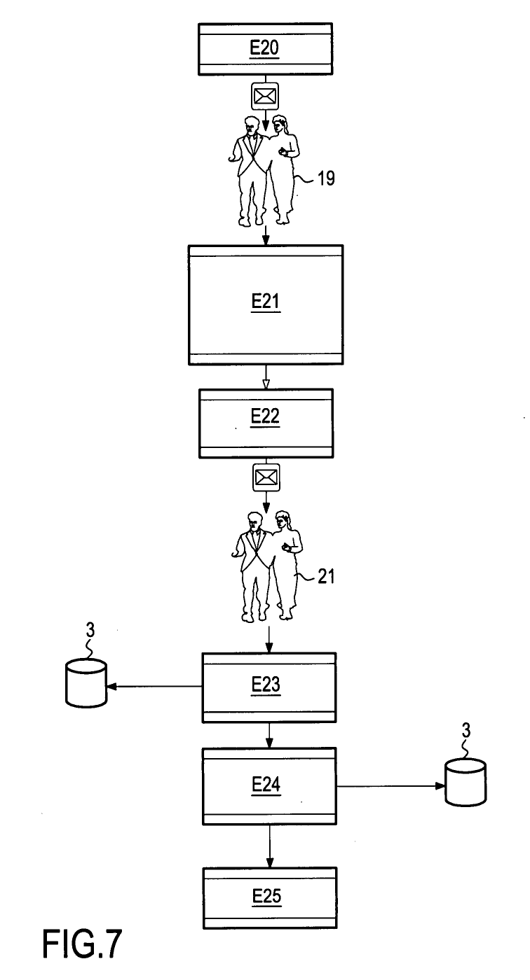

FIG. 7 is a diagram of the “pre-validation” scenario that chooses the users 21 to be migrated, chooses a main user from among those users, enters the login/pwd of the user 21, specifies the list of extensions to be backed up, and determines the volume potentially generated by backing up the data and parameters.

The step E20 sends a message to the person 19 who requested the migration requesting that person to draw up a list of the users 21 of the stations 15a to 17c ready for migration, to define the main user 21, and to choose the Extension profile.

The step E21 is carried out by the person 19 who requested the migration on the website of the synchronization server 1, and is initiated by that person 19 opening the message and clicking on the proposed URL.

Each person 19 carries out the following actions: selecting the profiles to be migrated from the list of profiles found by the inventory, selecting the main profile from among the profiles to be migrated, validating the list of extensions to be backed up, and specifying the data back-up path. This validation ends with a SetAction (CHOOSE_USER) that effects a PostAction.

The step E22 is a PostAction of the step E21. It generates an electronic mail to the main user 21 of the station 15a chosen by the person 19. This message contains information about the migration in progress.

The step E23 is carried out by the user 21, who enters the login/password of the station 15a at the URL contained in the message generated in the preceding step. This input is stored in encrypted form in the database 3 of the synchronization server 1. It ends with a SetAction (PWD_STORED). This action is followed by a PostAction that sends a message to the person 19 enabling new directories or new extensions to be added to the default directories and extensions. On subsequent pages, the user 21 finds information about his or her own profile (telephone, office number, floor, etc.). The user can add to or modify some of this information, of course. Also, additional information about the migration process can be supplied to the user 21.

The step E24 concerns determining or calculating the volume potentially generated by backing up the data and parameters and placing the result in the database 3 of the synchronization server. The synchronization server client MMBSSvc.exe generates the configuration file on the basis of a model deposited in the workstation 15a of the user 21 and modifies the command line to take account of all the data of the user 21 (profile, parameters), and a command Pre-scan.cmd is executed to analyze the data to be backed up.

In the step E25, the pre-validation scenario is completed and the last action of the scenario chains to the next scenario, which depends on the migration requested.

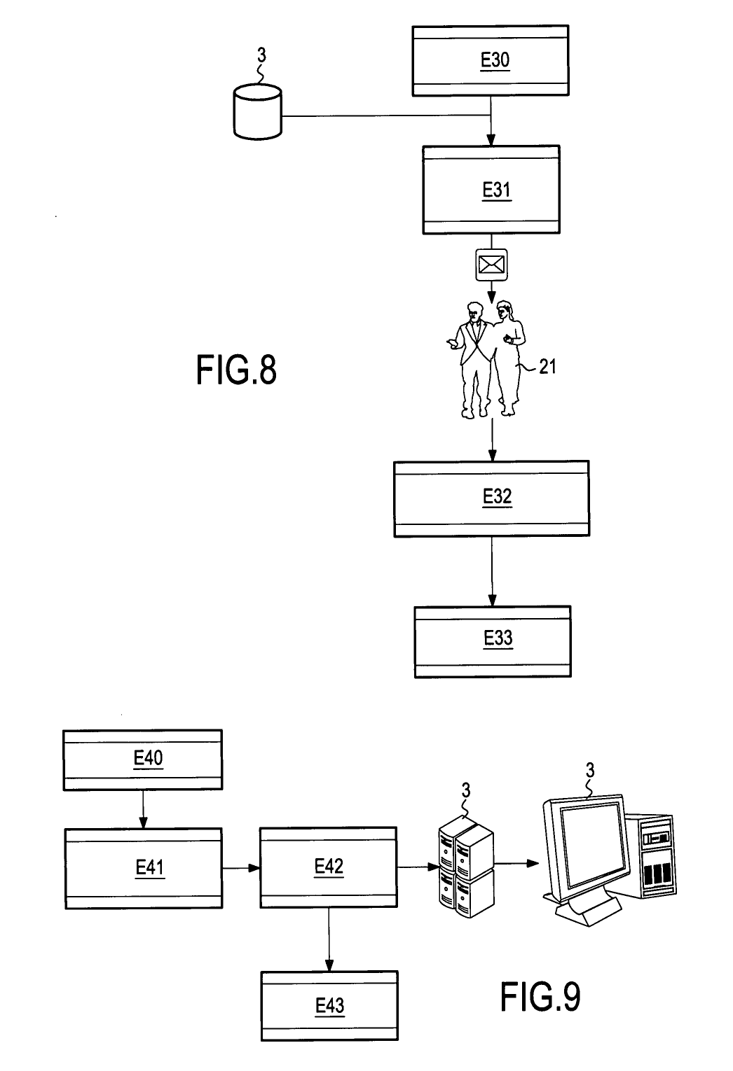

FIG. 8 is a diagram of the confirmation scenario enabling the person 19 who requested the migration to confirm that the volume of data to be backed up is not too large and to choose the software to be reinstalled from among the available software. This scenario cannot be restarted. If the person 19 considers that the volume is too large, that person negotiates with the user 21 to eliminate some large or old files and then confirms that the volume of data to be backed up is not too large.

The step E30 is a SetAction (Validation) initiated by a preceding scenario.

The step E31 prepares for validation of the migration by the person 19, initiated by a periodic script (for example daily at 08h00). Accordingly, a daily script is executed on the synchronization server 1. It mails a report to the person 19 that includes a URL enabling the person 19 to validate the data entered or stored automatically in the database 3 of the synchronization server 1.

In the next step E32, the person 19 who requested the migration goes to the site to execute the validation at the URL supplied in the message generated in the step E31. That person can validate each request for backing up data individually or globally and specify the software to be restored for each of the workstations 15a to 17c.

If the volume (defined individually, but also as a function of the storage space available on the local servers on the day of the migration) is too great, the person 19 must ask the main user 21 to clean up the storage disk.

If the space available on the storage disk is insufficient to perform the migrations within the particular period, the person 19 contacts each user 21 or changes the migration dates in order to smooth the operations in time.

In the step E33, the validation scenario is completed and the last action of the scenario chains to the next scenario, which depends on the migration requested.

FIG. 9 is a diagram of the scenario for depositing a “Ghost Clean Up light” image. This scenario deposits an image in advance.

The step E40 SetAction (GHOST_CUL) is initiated by a preceding scenario.

The step E41 prepares for deposition of the image (ghost) corresponding to the station 15a to be migrated. The synchronization server 1 client program receives the command MMCleanUp.exe LIGHT in response to the command GetNextAction. It executes it to make room on the storage disk. MMCleanUp.exe with the parameter LIGHT deletes unnecessary files on the workstation 15a (for example *.tmp, *.bak, etc. files) and sends a SetAction (CLEANUPOK). The PostAction of that SetAction is processed by the next step E42.

The step E42 deposits the ghost on the workstation 15a. The downloading server 5 is requested to deposit the corresponding ghost on the workstation 15a. The result of this deposition is not analyzed because it is merely intended to save time at the mastering stage.

In the step E43, the image deposition scenario is completed and the last action of the scenario chains to the next scenario, which depends on the migration requested.

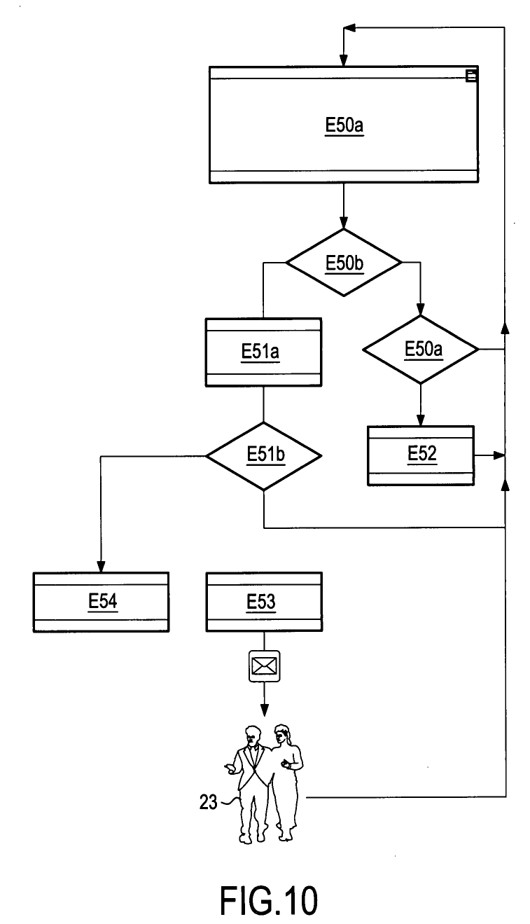

FIG. 10 is a diagram of the “start migration” scenario. This scenario requires the user 21 to participate in the migration of the user's workstation 15a. It communicates information about deployment to the user 21 and requests the user 21 to remove diskettes and CD-ROMs from the workstation 15a and to disconnect USB peripherals.

If the user 21 fails to respond, the local correspondent 23 has to intervene. If the local correspondent 23 does not intervene, the migration is suspended.

It can be restarted if the user 21 or the local correspondent 23 validates the screen displayed on the workstation 15a.

If the Windows session is closed, the window does not appear. The user 21 has up to 30 minutes before the scheduled migration time to request to restart later, for example.

The step E50a is initiated by a preceding scenario. On the station 15a of the user 21, the synchronization server 1 client polls the server to find out whether migration day has arrived. If the migration is not scheduled for this day, the client “goes back to sleep” for a time period specified in accordance with technical constraints.

Otherwise, if migration day has arrived, a pop-up window displayed on the desktop of the user 21 stating that migration day has arrived, for example from 09h30 if migration occurs during the morning or from 14h00 if migration occurs during the night. This pop-up prompts the user to remove diskettes, CD-ROMs, PDA, and USB peripherals. If the user 21 validates the pop-up (test E50b), then the next step is the step E51.

Otherwise, if the user cancels (test E50b), the pop-up is displayed again (step E50c), for example every hour until 30 minutes before migration time. Thereafter the step E52 is initiated.

The step E51a is executed on the station 15a of the user 21, on which the synchronization server 1 client executes API GetNextAction and in response receives the instruction to execute the verification script (test E51b) for verifying the presence of a diskette or CD-ROM.

If a diskette or CD-ROM is present, the next step is the step E50a. Otherwise, a SetAction (STATION_READY) is executed before proceeding to the step E54.

In the step E52, as migration time is approaching, a pop-up prompts the user 21 to perform the validation requested in the step E50a every 5 minutes (for example).

The step E53 is a script that is executed on the synchronization server 1 for migrations scheduled for that evening (for example at 18h00). This script looks for stations that have to be migrated that evening and that are not in the “STATION_READY” state. The list is sent by mail to the local correspondent 23 concerned who must perform the actions normally performed by the user 21 in the step E50a. To facilitate this task, the correspondent 23 is given the number of the room in which the computer 15a is located, if it is available in the directory or if the user 21 added it when validating.

In the step E54, the scenario for starting migration is completed and the last action of the scenario chains to the next scenario, which depends on the migration requested.

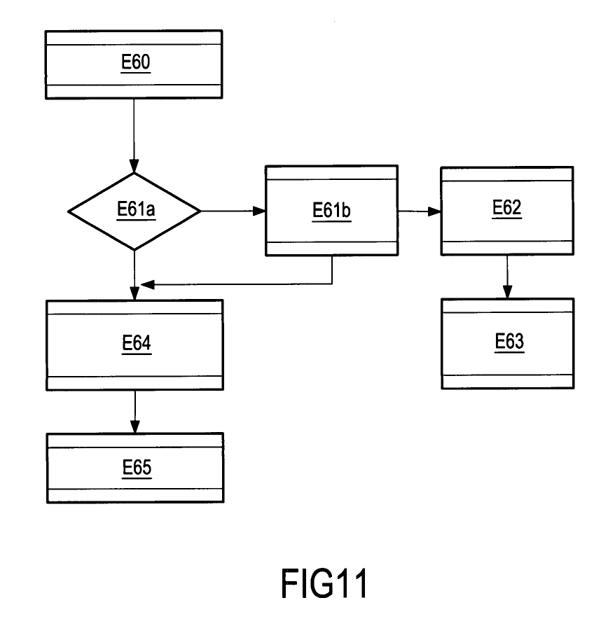

FIG. 11 is a diagram of the “back-up user data” scenario. This scenario backs up the data and parameters of the user 21 using the tool MMFilList.exe deposited previously. Moreover, if the user 21 is using Netscape™, the messaging data is copied to a remote server, in order to be converted to Outlook™. The step E60 (SetAction SAVEDATA) is initiated by a preceding scenario.

The step E61a (action returned by the GetNextAction) tests if the user 21 is using Netscape™ messaging. If so, the messaging data is copied to a remote server dedicated to the migration of Netscape™ data (step E61b).

The step E62 is a looped script that consults the synchronization server 1, recovers the identifiers for which data has been copied, and migrates PST format data accessible via the Outlook™ messaging client.

In the step E63, the PST data is copied to a local server to be restored later.

The step E64 backs up the data of the main user 21 and the data of other profiles chosen earlier from among the profiles found. It begins by generating the configuration file for MMFilList.exe. Throughout the backing up phase, which can take a long time, MMFilList.exe informs the synchronization server 1 of the activity of the station (API SetLog). This step continues with a SetAction (DATASAVED).

In the step E65, the scenario backing up the data of the user 21 is completed and the last action of the scenario chains to the next scenario, which depends on the migration requested.

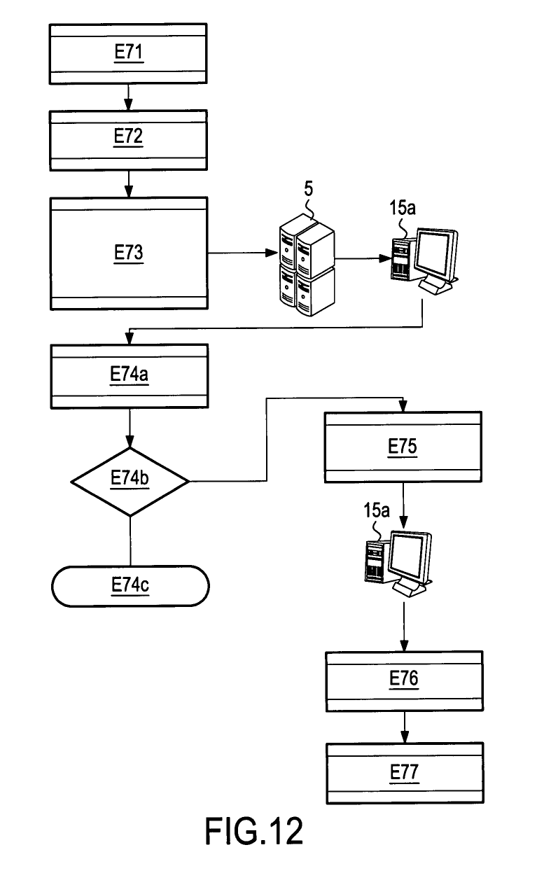

FIG. 12 is a diagram of the mastering scenario that deposits the XP ghost in place of the existing operating system of the workstation 15a.

The step E71 SetAction (MASTERING) is initiated by a preceding scenario.

The step E72 is initiated by a target station. Depending on the space available on the storage disk, a CleanUpHeavy is executed to clean up the disk and a SetAction (STATIONOK) is executed.

The step E73 is initiated by a SetAction STATIONOK. The PostAction to the SetAction STATIONOK submits a request to the downloading server 5 to distribute and install the XP ghost. If the ghost has already been deposited and is still present, it is not redeposited (capacity of the package which performs the CheckSum calculated on the package and on the station). Then, in the step E74a, a SetAction (GHOSTOK) is executed.

The step E74b tests the presence of diskettes or CD-ROMs. If either is present in the station 15a, the process is stopped in the step E74c.

Otherwise, the workstation 15a is remastered with the XP ghost in the step E75 by MMClone.exe deposited previously.

The step E76 consists of post-parametering of the newly installed workstation 15a (DNS, DHCP, station name, etc.). A program (MMSetAction.exe) is additionally executed that restores contact with the synchronization server 1.

In the step E77, the mastering scenario is completed and the last action of the scenario chains to the next scenario, which depends on the migration requested.

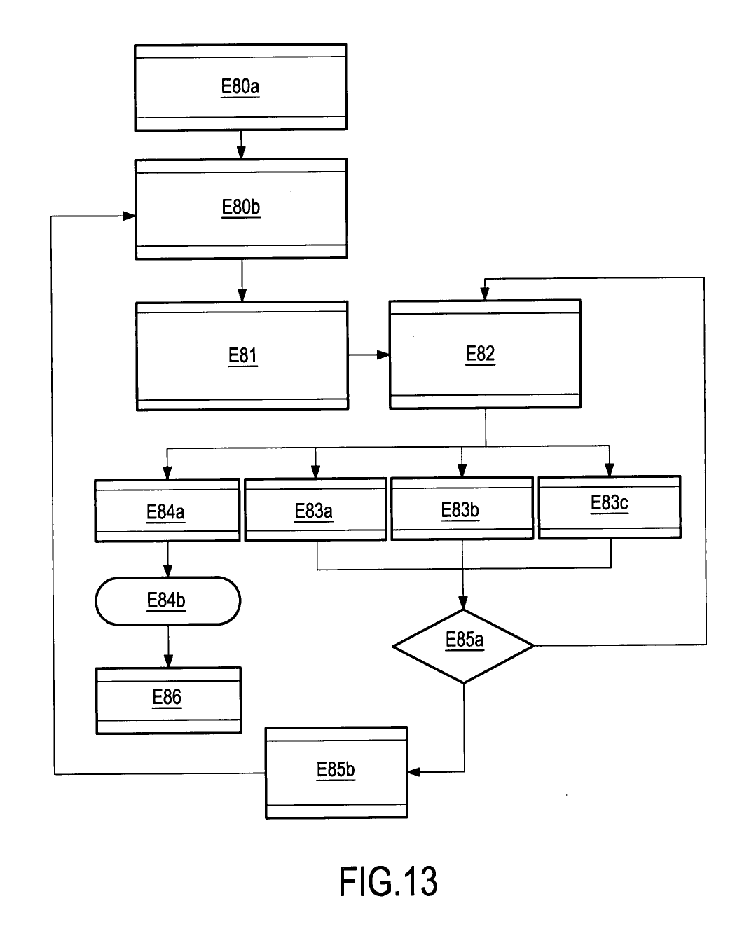

FIG. 13 is a diagram of the “re-install software” scenario, in which the step E80a is a SetAction (REINSTALSOFTWARE).

The step E80b opens a local administrator session having reading rights over the Domain Active Directory™.

In the step E81 (GetNextAction), the station 15a waits but the synchronization server 1 starts the software reinstallation process. The step E82 is a PostAction (RE-INSTALSOFTWARE) that searches the database for the next software to be installed.

In the step E83a, the synchronization server 1 requests Tivoli to distribute any software distributed by Tivoli.

In the step E83b the synchronization server 1 requests the distribution server 5 to distribute any software distributed by the distribution server 5.

In the step E83b, software is copied from an available network disk.

In the step E84a all the software has been installed, and the scenario stops in the step E84b.

The step E85a is a test to verify whether it is necessary to restart. If it is not necessary to restart, then the next step is the step E82. If it is necessary to restart then the next step is the step E85b for preparing the restart before returning to the step E80b.

In the step E86, the software reinstallation scenario is completed and the last action of the scenario chains to the next scenario, which depends on the migration requested.

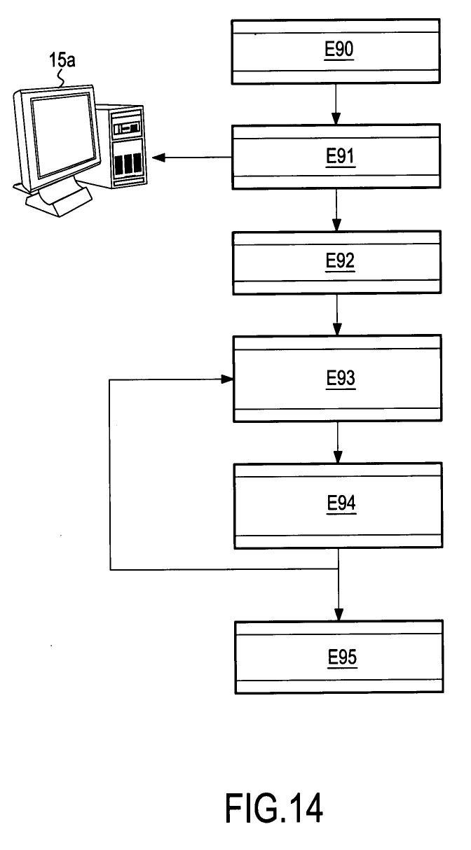

FIG. 14 is a diagram of the “restore user data” scenario. This scenario restores all user data and terminates the installation of Office™ and Outlook™.

The step E90 is a SetAction (RESTORE_DATA). Then, in the step E91, the user data is restored (RestaurationMMFilLIST.exe).

The step E92 restores messaging data converted from Netscape™ to Outlook™. The local server is searched for converted messaging data for this user 21. If any such data is found, it is copied to the workstation 15a.

The step E93 restarts the workstation 15a with the main user account. The parameter restoration software is restarted to terminate the tasks specific to the user 21.

In the step E94, Outlook™ is launched and the organization's standard post-parametering is carried out. The messaging profile is migrated and then Outlook™ is closed.

In the step E96, the data restoration scenario is completed and the last action of the scenario chains to the next scenario, which depends on the migration requested. The steps E93 and E94 are repeated as many times as there are users 21.

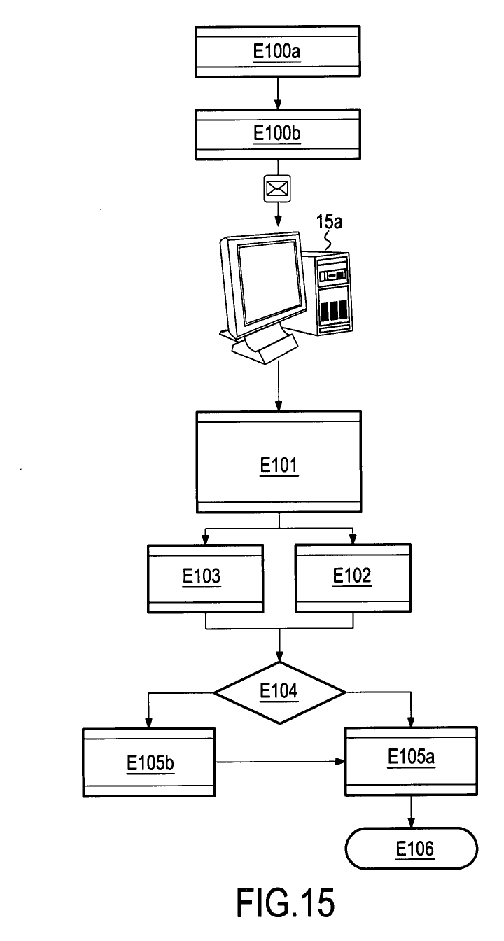

FIG. 15 is a diagram of the “canvassing” scenario which has three objectives. The first objective is to progress the tools by analyzing the reactions of users 21, the second objective is to have the user 21 validate the end of migration, and the third objective is to eliminate the data backed up before the migration to free up space on the storage disk.

The step E100a is a SetAction (CANVASSING). In the step E100b (executed on day D+3 for example), a script executed on the synchronization server generates and sends the user an electronic mail that contains a URL.

In the step E101, the user 21 answers the questions asked at the URL sent in that electronic mail. The questions, which are preferably simple and few in number, relate to the migration and not to the use of the new version of the operating system. The user nevertheless has a free text area for entering comments, which are routed either to the migration team or to the team responsible for designing the masters.

The step E102 reads the comments entered by the user 21.

The step E103 is one of automatic (for example daily) collection of results and of sending a report to the manager or to the person 19 who requested the migration. There follows the step E105a in which users who confirm that their data has been restored correctly can eliminate the backups.

Otherwise, the next step is the step E105b, which is a call for giving post-migration support to users who have lost data by analyzing and extracting data backed up before migration and reinstalling it.

In the step E106, it is considered that the operation has finished.

1. A method of migrating an operating system, user data, and applications from a server to a computer connected to said server via an information network, wherein that migration is effected by automatically chaining a set of steps organized as a function of initial data and/or interaction between said computer (15a) and said server, wherein said set of steps comprises:
initializing said computer;
analyzing said computer to verify whether it is able to support the migration; and
loading said operating system, said user data, and said applications onto said computer, including a downloading server (5) depositing an image of said operating system on a storage disk of said computer (15a) by sending said computer (15a) the name of a depositary computer of said image belonging to a local area network (15) to which said computer (15a) is connected and that has previously downloaded said image or by sending said computer (15a) the address of a central storage location (11) containing said image if said local area network (15) does not include another computer that has previously downloaded said image.

2. The method according to claim 1, wherein, when a next step must be executed after a preceding step, said preceding step includes a final command for initiating automatic starting of the next step.

3. The method according claim 1, wherein said initial data is stored by a person (19) who requested the migration in a database (3) of a synchronization server (1) and includes a migration type, times of execution of the steps, and the name(s) of said computer and/or its user(s).

4. The method according to claim 1, wherein said step of initialization is effected by automatically chaining a first set of steps comprising:
the synchronization server (1) requesting the downloading server (5) to install a program necessary for said migration type on said computer (15a);
the downloading server (5) installing said program on said computer (15a);
the downloading server (5) executing said program; and
the synchronization server (1) initiating a next step as a function of said migration type.

5. The method according to claim 1, wherein said step of analyzing said computer comprises automatic chaining of a second set of steps comprising:
making an inventory of said computer (15a) comprising lists of installed applications and/or profile(s) of the user(s) (21) and technical and location parameters of said computer (15a) and storing said inventory in the database (3) of the synchronization server (1); and
the synchronization server (1) initiating a next step as a function of the migration type.

6. The method according to claim 5, wherein said step of analyzing said computer further comprises automatic chaining of a third set of steps comprising:
analyzing the capacity of said computer (15a) to support the migration;
sending information to the synchronization server (1) for interrupting the automatic process if said computer (15a) does not have the capacity necessary for the migration until modification of said computer enables it to support the migration;
restarting the automatic process when said computer has the capacity to support said operating system; and
the synchronization server (1) initiating a next step as a function of the migration type.

7. The method according to claim 1, wherein said step of loading said operating system onto said computer comprises automatic chaining of a fourth set of steps comprising:
cleaning up the storage disk of said computer (15a) to make room for depositing an image of said operating system by eliminating files known to be unnecessary in the database (3) of the synchronization server (1);
depositing said image of said operating system on said storage disk of said computer (15a); and
the synchronization server (1) initiating a next step as a function of the migration type.

8. The method according to claim 1, further comprising a step of preparing a back up of data of said user(s) comprising automatic chaining of a fifth set of steps comprising:
the person (19) who requested the migration choosing profiles to be backed up from profiles found on said computer;
said person who requested the migration choosing wanted applications to be reinstalled after migration from among the applications found on said computer and/or from a list of available applications;
determining the storage volume necessary for backing up the data corresponding to the chosen profile(s) and application(s);
the synchronization server (1) reserving said storage volume on a back-up server; and
the synchronization server (1) initiating a next step as a function of the migration type.

9. The method according to claim 1, further comprising a step of backing up data of the user(s) comprising automatic chaining of a sixth set of steps comprising:
informing the user (21) of the beginning of the back-up step to prompt the user to close his or her applications and session;
verifying that said computer (15a) contains no bootstrap external storage element and, if it does, sending an alert prompting the user to remove said bootstrap external storage element;
restarting said computer;
backing up data of the user(s) on said back-up server; and
the synchronization server (1) initiating a next step as a function of the migration type.

10. The method according to claim 7 wherein said step of loading said operating system onto said computer further comprises automatic chaining of a seventh set of steps comprising:
loading said operating system onto said storage disk of said computer (15a);
setting particular parameter values of said computer; and
the synchronization server (1) initiating a next step as a function of the migration type.

11. The method according to claim 1, further comprising a step of restoring backed up data comprising automatic chaining of a eighth set of steps comprising:
storing the backed up data on said computer (15a);
verifying the quality of the backed up data; and
the synchronization server (1) initiating a next step as a function of the migration type.

12. The method according to claim 1, further comprising a step of installing said wanted applications chosen by said person who requested the migration before and/or after the restoration of said backed up data comprising automatic chaining of a ninth set of steps comprising:
the synchronization server (1) requesting the downloading server (5) to install a first application on said computer;
the synchronization server verifying correct installation of said application and effecting a particular number of retries if installation has failed;
the synchronization server (1) requesting the downloading server (5) to install a next application on said computer;
repeating the previous two steps until all applications chosen by said person who requested the migration have been reinstalled; and
the synchronization server initiating a next step of terminating operation or declaring a fault.

13. A computer program adapted to execute the method according to claim 1, when the computer program is executed by a computer system (1, 3, 5, 7, 9, 15a).

14. A system for migrating an operating system and applications from a server to a computer connected to said server via an information network (13), comprising a synchronization server (1) connected to a downloading server (5), an inventory server (7), and a back-up server (9) adapted to effect the migration by automatically chaining a set of steps organized as a function of initial data and/or interaction between said computer (15a) and said servers and comprising initializing said computer, analyzing said computer to verify whether it can support the migration, and loading said operating system and said applications onto said computer, said loading comprising a downloading server (5) depositing an image of said operating system on a storage disk of said computer (15a) by communicating to said computer (15a) the name of a depositary computer of said image belonging to a local area network (15) to which said computer (15a) is connected and that has previously downloaded said image or by communicating to said computer (15a) the address of a central storage location (11) containing said image if said local area network (15) does not include another computer that has previously downloaded said image.
